(19) United States
(12) Patent Application Publication
(10) Pub. No.: US 2025/0384321 A1
(43) Pub. Date: Dec. 18, 2025

(54) HYBRID ANNEALING CHARACTERIZATION OF A PROBABILITY DISTRIBUTION OF THE QUBO SOLUTIONS

(71) Applicant: Dell Products L.P., Round Rock, TX (US)

(72) Inventors: Miguel Paredes Quiñones, Campinas (BR); Ítalo Gomes Santana, Rio de Janeiro (BR); Diego Vrague Noble, Pelotas (BR)

(21) Appl. No.: 18/677,291

(22) Filed: May 29, 2024

(51) Int. Cl. G06N 10/60; G06F 17/18

(52) U.S. Cl. CPC G06N 10/60; G06F 17/18

(57) ABSTRACT

Determining a probability distribution for a solution is disclosed. A diagonal of a QUBO matrix is evaluated. When the diagonal is positive semidefinite, the QUBO may be solved using a simulated annealer and a solution can be sampled to determine a probability distribution. If the diagonal is not positive semidefinite, the QUBO may be sampled using a simulated annealer in an intermediate step. If a variance of a dispersion measure is too large, the QUBO is solved and sampled using a quantum annealer in order to determine the probability distribution.

### TECHNOLOGICAL FIELD OF THE DISCLOSURE

Embodiments of the present invention generally relate to quantum computing systems and quantum computing related operations. More particularly, at least some embodiments of the invention relate to systems, hardware, software, computer-readable media, and methods for characterizing probability distributions of models such as quadratic unconstrained binary optimization (QUBO) models and/or to training machine learning models including (Quantum) Boltzmann Machines and/or (Quantum) Restricted Boltzmann Machines.

### BACKGROUND

A combinatorial problem often involves a scenario where there is a desire to identify a good or suitable solution from among a very large number of possible solutions. The traveling salesperson problem is an example of a combinatorial optimization problem. Quantum computing systems, such as quantum annealers, are often used to identify a suitable solution to a combinatorial problem.

A combinatorial problem (or other type) may be represented in a format such as QUBO model. In one example, a QUBO is a single multivariable quadratic polynomial whose solution is obtained by minimizing an energy function in a quantum annealer. More specifically, QUBO problems can be viewed as probability distributions. Solving (or sampling) a QUBO results in a solution (or sample) represented by an energy value. In many use cases, sampling a QUBO may be performed to determine a probability distribution rather than an optimal or suitable solution.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be limiting of the scope of this disclosure, embodiments will be described and explained with additional specificity and detail through the use of the accompanying drawings, in which:

FIG. 1 discloses aspects of a QUBO;

FIG. 2 discloses aspects of determining a probability distribution associated with a QUBO;

FIG. 3 discloses aspects of training a machine learning model such as a (Quantum) Boltzmann Machine; and

FIG. 4 discloses aspects of a computing device, system, or entity.

### DETAILED DESCRIPTION OF SOME EXAMPLE EMBODIMENTS

Embodiments disclosed herein generally relate to quadratic unconstrained binary optimization (QUBO) models and problems. More particularly, at least some embodiments relate to systems, hardware, software, computer-readable media, and methods for characterizing probability distributions of QUBO solutions and/or to orchestrating the execution of QUBO problems in quantum and/or simulated annealers. Embodiments of the invention further relate to training (Quantum) Boltzmann Machines (Q)BMs and (Quantum) Restricted Boltzmann Machines (Q)RBMs.

Embodiments of the invention are discussed in the context of QUBO models but are not limited thereto. Embodiments of the invention may be applied to other models including Ising models. Embodiments of the invention are further discussed in the context of quantum annealers including physical annealers.

Quantum annealing is performed in a quantum annealer, which is a type of quantum computer. A quantum annealer (QA) typically uses quantum bits or qubits to solve problems. Simulated annealing (SA) is a metaheuristic performed in classical computing systems that resembles, by way of example, the annealing process on metallurgy where a QUBO can be encoded on the simulation of a process of controlled cooling of a metal. Simulated annealing can provide good solutions for a large range of problems. However, there is evidence that a quantum annealer can determine a global minimum of some problems exponentially more quickly than a simulated annealer. A global minimum is a solution with highest quality or, analogously, with the lowest energy value in energy-based functions, such as the Hamiltonian function.

Quantum annealing, in general, interpolates between a static problem-independent Hamiltonian for which a ground state can be efficiently prepared, and a final Hamiltonian whose ground state yields a desired solution. The quantum annealer linearly interpolates between H₀ and H_{f} (H_{f}=Q) as follows: H(t)=α(t)H₀+β(t)H_{f}. In this example, H_{f} is the Hamiltonian of the problem to be solved. This system represented by H(t) evolves following the time-dependent Schrödinger equation.

In one example, sampling on a QUBO can be used to find or estimate a probability distribution rather than an optimal or suitable solution. For example, Boltzmann Machines (BMs) are unsupervised machine learning models that may be broadly trained using quantum annealers.

More specifically, BMs can be interpreted as two-layered stochastic neural networks used to learn important aspects of unknown probability distributions based on a set of their samples. In their canonical form, BMs are fully connected in their topology (i.e., all nodes connect to each other). This topology makes computing exact energy values for sampling impractical.

To enable faster sampling in BMs, Restricted BMs (RBMs) restrict all possible interlayer node connections to be non-zero whereas the remaining connections are zeroed. Stated differently, RBMs are complete bipartite graphs. Due to the energy-based nature of BMs and RBMs, quantum annealers may be used to train these models and these models are often referred to as Quantum BMs (QBMs) and Quantum RBMs (QRBMs).

One advantage in using quantum annealers for Q(R)BMs is speeding up the optimization process to train these models and improving solution quality on non-convex QUBO problems when compared to classical solution approaches, such as simulated annealing (SA). When the QUBO is convex, SA becomes a more appropriate solver in terms of computational time and solution quality at least because solving convex QUBOs is typically less complex computationally than non-convex problems.

Using quantum annealers is typically more expensive compared to using simulated annealers, which run on classical computing systems (e.g., CPU (central processing unit) or GPU (graphic processing unit)), at least because quantum annealers are specialized devices with high usage demand that cannot be easily instantiated or virtualized. The need to use a quantum annealer is often preferred or necessary when finding the optimal solutions is complicated, that is, the search space landscape is rugged with numerous plateaus and local minimums. However, determining whether a QUBO should be solved using a quantum annealer iteratively in the context of characterizing a probability distribution is achieved in embodiments of the invention.

In one example, training RBMs using quantum annealers includes solving or sampling multiple QUBOs until a convergence (i.e., obtaining a probability distribution) is found is an arduous task and demands some kind of orchestration of computational resources to effectively manage all available computational resources because computational time and solution quality are important aspects of obtaining high-quality probability distributions to train these types of models. Training (Q)RBMs may include multiple iterations and each of the iterations may be associated with a different QUBO. Embodiments of the invention can reduce the training time by determining whether to employ a QA or a SA during the training process. In one example, the probability distribution used is determined by sampling the solution of the last QUBO.

Generally, embodiments of the invention relate to scenarios where an orchestration tool is required to manage the utilization of a quantum annealer. Embodiments of the invention further relate to identifying QUBOs that can be solved using a simulated annealer. In a system that includes numerous QUBO produced in edge devices that need to optimize a problem non-locally, embodiments of the invention are configured to identify the QUBOs that can be performed or sampled using simulated annealers and/or the QUBOs that should be performed or sampled using a quantum annealer.

In one example, embodiments of the invention are configured to reduce the usage of quantum annealers. As previously stated, using quantum annealers is expensive due in part to the fact that quantum annealers are specialized equipment. Quantum annealers, in addition, are scarce and often in high demand, which complicates scheduling.

Simulated annealers, however, can be used in some circumstances. More specifically, the complexity of a quantum annealer can be replaced with analytical decisions and a simulated annealer. For example, this problem appears in the training of QBMs (and QRBMs), because solving QUBOs at every batch iteration implemented on stochastic gradient descent will update the QUBO coefficients by the gradient values. These parameters change the QUBO until convergence. In some instances, and in light of the changed parameters, it may be desirable to solve the QUBO using a quantum annealer. In other instances, it may be desirable to solve the QUBO using a simulated annealer.

In one example, embodiments of the invention are configured to obtain a probability distribution of a dataset by performing an analytical decision regarding the hardness of the problem prior to solving the problem in a quantum annealer of a simulated annealer. In one example, a simulated annealer is preferred over a quantum annealer at least because of the cost concerns and scheduling concerns associated with quantum annealers. Embodiments of the invention perform an intermediary evaluation that includes quickly sampling solutions from the QUBO using the simulated annealer followed by a statistical analysis over the resulting energy values before confirming the QUBO resolution on a quantum annealer.

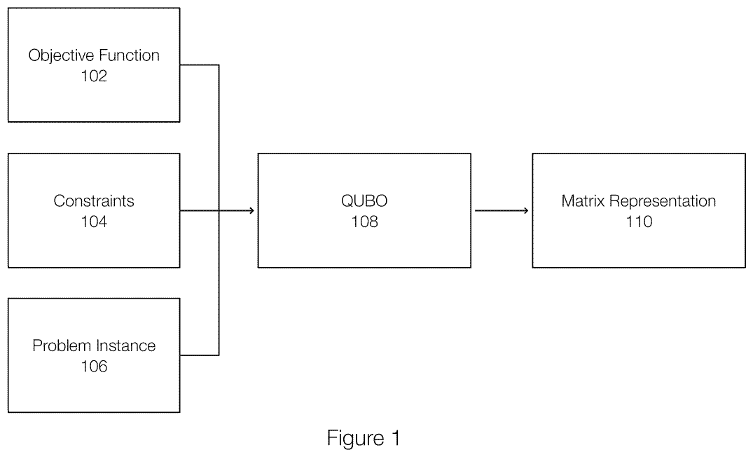

FIG. 1 discloses aspects of a QUBO. FIG. 1 illustrates an example where an objective function 102, constraints 104, and a problem instance 106 are transformed into a QUBO 108. The objective function 102 is often used to represent how a particular combination of variables satisfies or solves a problem such as a combinatorial problem. The objective function 102 mathematically expresses a problem using binary values xᵢ. For example, an objective function may be represented as:

$$H ( x ) = {\sum }_{i < j} {q}_{i , j} {x}_{i} {x}_{j} + {\sum }_{i} {q}_{i , j} {x}_{i}^{2} = {x}^{T} Qx .$$

As illustrated, the objective function 102 may include a linear term and a quadratic term. When solving a QUBO, the goal is to identify the variable assignments that minimize the objective function 102. A QUBO may have a large number of variables and the process of determining or identifying a solution may attempt to select a best known or optimal solution from all of the possible combinations.

Although a QUBO may be unconstrained, the constraints 104 are often introduced. The constraints 104 may ensure that some unfeasible solutions are avoided. For example, the constraints 104 may be configured to penalize solutions that violate the constraints, thus, avoiding the consideration of these solutions. The problem instance 106 may be a specific representation of a general problem definition in one example. The problem instance 106, for example, may include the parameters and constraints of a specific occurrence of the objective function 102.

Thus, in one example, the objective function 102, the constraints 104, and the problem instance 106 are transformed into the QUBO 108. The QUBO 108 may have a matrix representation 110. When using the matrix representation 110, a QUBO may be represented as:

$${x}^{T} Qx .$$

A QUBO matrix is a representation of the coefficients associated with a QUBO formulation. In one example, for a problem with n binary variables, the QUBO matrix 110 is an n×n matrix. In this example, entries in the i^{th} row and j^{th} column corresponds to a coefficient q_{i,j} term involving the variables xᵢ and xⱼ. Stated differently, a QUBO matrix is a matrix of pairwise qubits with their entanglement coefficients as values of the QUBO matrix.

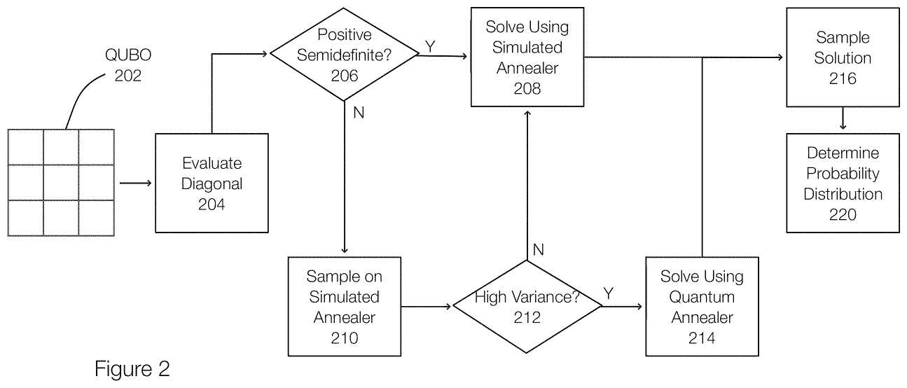

FIG. 2 discloses aspects of characterizing a probability distribution of QUBO solutions and aspects of solving a QUBO using a simulated annealer and/or a quantum annealer. FIG. 2 illustrates a QUBO matrix 202 (Q_{B}). In this example, a diagonal of the matrix 202 is evaluated 204. The evaluation includes determining whether the elements of the diagonal of the matrix 202 are all positive. If all the elements of the diagonal are positive (Y at 206), then the matrix 202 is positive semidefinite and the matrix 202 (or QUBO) is solved 208 using a simulated annealer. Determining whether the elements of the diagonal are positive is computationally inexpensive and linear in nature. If the elements are not all positive, a more expensive, but still comparatively inexpensive sampling 210 (compared to a quantum annealer) is performed on a simulated annealer.

In one example, the matrix 202 is a symmetrical matrix (i.e., identical to its transpose) that can be converted into a triangular matrix. On a triangular matrix, the eigen values are equal to diagonal elements. If all eigenvalues are positive, then the QUBO is convex in the objective function. QUBOs that are convex in the objective function are typically easier to solve. As a result, solving 208 the matrix 202 on a simulated annealer is sufficient for obtaining low-energy solutions or samples to characterize a probability distribution. Thus, the solution from the simulated annealer is sampled 216 and a probability distribution is determined 220. In one example, the probability distribution can be determined from a single sample.

If any element of the diagonal is negative, the QUBO is not positive semidefinite (N at 206). More specifically, if any element of the diagonal of the matrix 202 is negative, the matrix 202 may be indefinite and a quantum annealer may be a better choice because this suggests that the QUBO is more difficult.

In one example, when the matrix is not positive semidefinite (N at 206), an intermediary sampling is performed 210 on a simulated annealer. The intermediate sampling is performed to determine whether the QUBO is hard enough to be sent to a quantum annealer. In one example, sampling 210 on a simulated annealer includes using the simulated annealer to obtain some samples of the probability distribution and then using the samples to determine whether the simulated annealer is sufficient for characterizing the distribution by considering one or more dispersion measures and one or more predefined thresholds. Examples of dispersion measures may include variance, standard deviation, value range, or the like.

If the dispersion is below a threshold (does not have high variance or N at 212), then the QUBO is solved 208 using a simulated annealer. Once completed, the solution is sampled 216 (may include previous samples from 210) and the probability distribution is determined 220.

If high variance is present in the dispersion measures (Y at 212), then the simulated annealer did not attain a sufficient quality in sampling and the QUBO is solved 214 using a quantum annealer. The solution of the quantum annealer is sampled 216 and the probability distribution is determined 220.

The samples obtained at 210 can be used to characterize the distribution in some instances. However, these solutions may not be representative because most low-energy solutions can only be attained using a quantum annealer. In addition, embodiments of the invention are not limited to sampling methods associated with simulated annealers. Other metaheuristics may be used.

Embodiments of the invention thus relate to selecting either quantum annealing or simulated annealing by performing an analytical analysis of a QUBO. This is performed using intrinsic features, such as determining whether the diagonal of the QUBO matrix is positive semidefinite. Embodiments of the invention advantageously orchestrate the execution of QUBOs by selecting a system for solving the QUBO in a manner that reduces the demand for scarce hardware (e.g., quantum annealers) without impacting the final probability distribution.

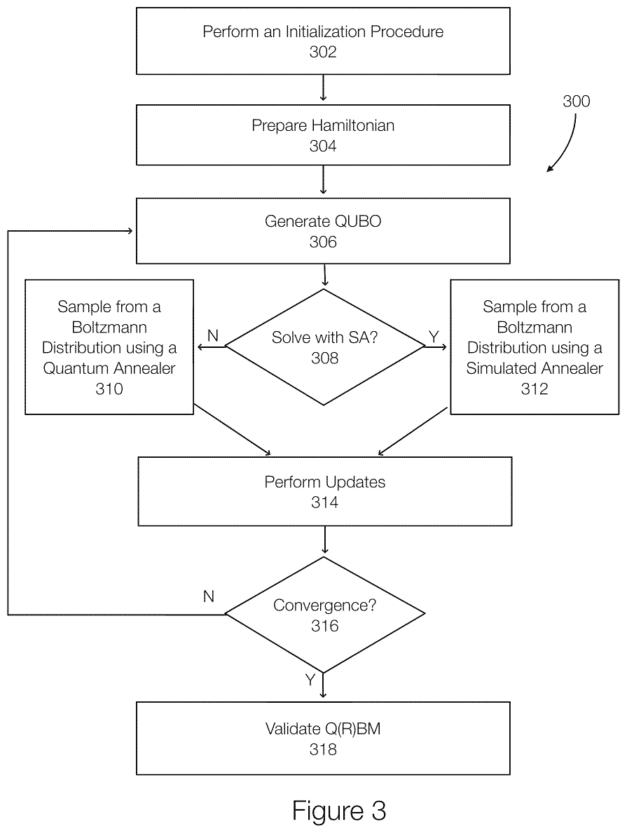

FIG. 3 discloses aspects of training a quantum Boltzmann Machine (Q(R)BM). The method 300 includes performing 302 an initialization procedure or process. This may include preparing or setting an architecture of the Boltzmann machine and may include initializing the weights. The weights may be initialized randomly or using a heuristic.

Next, a Hamiltonian, which represents the energy function of the Q(R)BM, may be prepared or determined. A QUBO is generated 306 based on the Hamiltonian.

Once a QUBO is generated 306, the method 300 may determine whether to solve or sample the QUBO using an SA or a QA (Y or N at 308) as described with reference to FIG. 2. If the method 300 determines to use an SA (Y at 308), the Boltzmann distribution is sampled 312 (e.g., by solving the QUBO and sampling the solution) using an SA. If the method 300 determines to use a QA (N at 308), the Boltzmann distribution is sampled 310 using a QA.

In either case, once the Boltzmann distribution is sampled, updates are performed 314. The updates to the Q(R)BM may include determining gradients and updating parameters.

If convergence has occurred (Y at 316), then the trained Q(R)BM may be validated 318. If convergence has not occurred (N at 316), another iteration may be performed. In this case, the QUBO is different and, as a result, it may be necessary to determine whether to solve or sample with an SA or a QA as previously discussed.

FIG. 3 demonstrates that a QBM or QRBM may be trained using QUBOs and QAs or SAs. By determining whether a QUBO can be solved or sampled using an SA, the training process can be completed more quickly and more efficiently. Further, sampling the last QUBO may determine a probability distribution that is incorporated into the final trained Boltzmann Machine.

Embodiments of the invention discuss both solving and sampling QUBOs. By way of example only, solving a QUBO on a simulated annealer may result in a solution that allows the probability distribution of the QUBO to be characterized sufficiently even though the solution space in a simulated annealer may be limited. Further, samples allows variances in dispersion measurements to be determined and may also allow the probability distribution to the determined.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, quantum operations, probability determination operations, sampling operations from a QUBO solution, QUBO analysis operations, or the like or combinations thereof. More generally, the scope of this disclosure embraces any operating environment in which the disclosed concepts may be useful. New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable perform operations initiated by one or more clients or other elements of the operating environment.

Example cloud computing environments, which may or may not be public, include storage environments that may provide data protection functionality for one or more clients. Another example of a cloud computing environment is one in which processing, data protection, machine model execution/training, quantum operations, and other, services may be performed on behalf of one or more clients. Some example cloud computing environments in connection with which embodiments may be employed include, but are not limited to, Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ is intended to be broad in scope. Example embodiments are applicable to any system capable of storing and handling various types of objects, in analog, digital, or other form.

It is noted that any operations of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method for determining how to solve a quantum unconstrained binary optimization (QUBO), the method comprising: evaluating a diagonal of a matrix associated with the QUBO to determine whether the diagonal is positive semidefinite, solving the QUBO when the diagonal is positive semidefinite using a simulated annealer, sampling the QUBO on the simulated annealer when the diagonal is not positive semidefinite and solving the QUBO on the simulated annealer when a variance is less than a threshold variance, and solving the QUBO on a quantum annealer when the variance obtained from sampling the QUBO on the simulated annealer is greater than or equal to the variance, and characterizing a probability distribution of the QUBO based on the solution obtained from the simulated annealer of the quantum annealer; and incorporating the probability distribution into training a machine learning model.

Embodiment 2. The method of embodiment 1, wherein the variance comprises a variance of a dispersion measure.

Embodiment 3. The method of embodiment 1 and/or 2, wherein the dispersion measure is one or more of a standard deviation, a value range, or a variance.

Embodiment 4. The method of embodiment 1, 2, and/or 3, wherein the machine learning model is a Boltzmann Machine, a restricted Boltzmann Machine, a quantum restricted Boltzmann Machine, or a quantum Boltzmann Machine.

Embodiment 5. The method of embodiment 1, 2, 3, and/or 4, wherein the training includes multiple iterations and each of the iterations is associated with a QUBO and a last iteration is associated with a last QUBO that characterizes a probability distribution of the machine learning model.

Embodiment 6. The method of embodiment 1, 2, 3, 4, and/or 5, further comprising generating the matrix.

Embodiment 7. A method for training a Boltzmann Machine, the method comprising: performing an initialization procedure to define an initial quantum state, iteratively, until training converges: determining a QUBO, determining whether to solve the QUBO using a simulated annealer or quantum annealer based on whether a diagonal of the QUBO is positive semidefinite, solving the QUBO with a simulated annealer when the diagonal is positive semidefinite, wherein the QUBO is solved with a quantum annealer when the diagonal is not positive semidefinite and a variance of the QUBO on the simulated annealer is greater than a threshold variance, and updating the Boltzmann Machine using a probability distribution of the QUBO.

Embodiment 8. The method of embodiment 7, further comprising preparing a Hamiltonian.

Embodiment 9. The method of embodiment 7 and/or 8, further comprising sampling the QUBO on the simulated annealer when the diagonal is not positive semidefinite to obtain one or more samples, wherein the variance includes a variance of at least one dispersion measurement that is determined by the one or more samples.

Embodiment 10. The method of embodiment 7, 8, and/or 9, wherein the at least one dispersion measurement is one or more of a standard deviation, a value range, or a variance.

Embodiment 11. The method of embodiment 7, 8, 9, and/or 10, wherein the Boltzmann machine is a restricted Boltzmann machine, a quantum Boltzmann machine, or a quantum restricted Boltzmann machine.

Embodiment 12. The method of embodiment 7, 8, 9, 10, and/or 11, wherein updating the Boltzmann Machine includes updating gradients and parameters.

Embodiment 13. The method of embodiment 7, 8, 9, 10, 11, and/or 12, further comprising validating the Boltzmann Machine once convergence is achieved.

Embodiment 14. A system, comprising hardware and/or software, operable to perform any of the operations, methods, or processes, or any portion of any of these, disclosed herein.

Embodiment 15. A non-transitory storage medium having stored therein instructions that are executable by one or more hardware processors to perform operations comprising the operations of any one or more of embodiments 1-13.

The embodiments disclosed herein may include the use of a special purpose or general-purpose computer including various computer hardware or software modules, as discussed in greater detail below. For example, simulated annealers may include the use of a special purpose or general-purpose computer. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

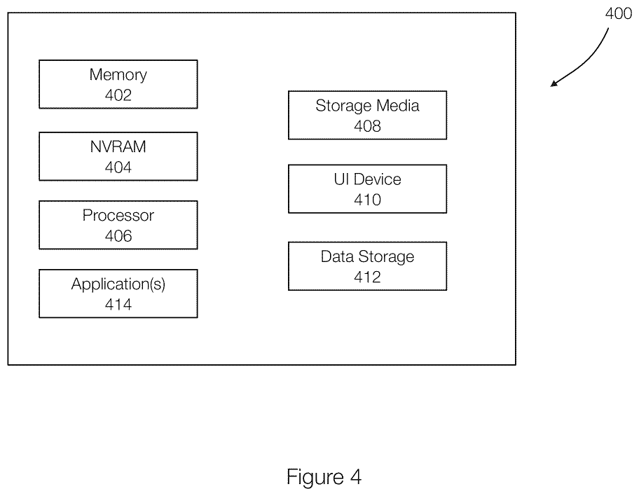

With reference briefly now to FIG. 4, any one or more of the entities disclosed, or implied the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid-state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for determining how to solve a quantum unconstrained binary optimization (QUBO), the method comprising:
evaluating a diagonal of a matrix associated with the QUBO to determine whether the diagonal is positive semidefinite;
solving the QUBO when the diagonal is positive semidefinite using a simulated annealer;
sampling the QUBO on the simulated annealer when the diagonal is not positive semidefinite and solving the QUBO on the simulated annealer when a variance is less than a threshold variance; and
solving the QUBO on a quantum annealer when the variance obtained from sampling the QUBO on the simulated annealer is greater than or equal to the variance; and
characterizing a probability distribution of the QUBO based on the solution obtained from the simulated annealer of the quantum annealer; and
incorporating the probability distribution into training a machine learning model.

2. The method of claim 1, wherein the variance comprises a variance of a dispersion measure.

3. The method of claim 2, wherein the dispersion measure is one or more of a standard deviation, a value range, or a variance.

4. The method of claim 1, wherein the machine learning model is a Boltzmann Machine, a restricted Boltzmann Machine, a quantum restricted Boltzmann Machine, or a quantum Boltzmann Machine.

5. The method of claim 4, wherein the training includes multiple iterations and each of the iterations is associated with a QUBO and a last iteration is associated with a last QUBO that characterizes a probability distribution of the machine learning model.

6. The method of claim 1, further comprising generating the matrix.

7. A non-transitory storage medium having stored therein instructions that are executable by one or more hardware processors to perform operations for determining how to solve a quantum unconstrained binary optimization (QUBO), the operations comprising:
evaluating a diagonal of a matrix associated with the QUBO to determine whether the diagonal is positive semidefinite;
solving the QUBO when the diagonal is positive semidefinite using a simulated annealer;
sampling the QUBO on the simulated annealer when the diagonal is not positive semidefinite and solving the QUBO on the simulated annealer when a variance is less than a threshold variance; and
solving the QUBO on a quantum annealer when the variance obtained from sampling the QUBO on the simulated annealer is greater than or equal to the variance; and
characterizing a probability distribution of the QUBO based on the solution obtained from the simulated annealer of the quantum annealer; and
incorporating the probability distribution into training a machine learning model.

8. The non-transitory storage medium of claim 7, wherein the variance comprises a variance of a dispersion measure.

9. The non-transitory storage medium of claim 8, wherein the dispersion measure is one or more of a standard deviation, a value range, or a variance.

10. The non-transitory storage medium of claim 7, wherein the machine learning model is a Boltzmann Machine, a restricted Boltzmann Machine a quantum restricted Boltzmann Machine or a quantum Boltzmann Machine.

11. The non-transitory storage medium of claim 10, wherein the training includes multiple iterations and each of the iterations is associated with a QUBO and a last iteration is associated with a last QUBO that characterizes a probability distribution of the machine learning model.

12. The non-transitory storage medium of claim 10, further comprising generating the matrix.

13. A method for training a Boltzmann Machine, the method comprising:
performing an initialization procedure to define an initial quantum state;
iteratively, until training converges:
determining a QUBO;
determining whether to solve the QUBO using a simulated annealer or quantum annealer based on whether a diagonal of the QUBO is positive semidefinite;
solving the QUBO with a simulated annealer when the diagonal is positive semidefinite, wherein the QUBO is solved with a quantum annealer when the diagonal is not positive semidefinite and a variance of the QUBO on the simulated annealer is greater than a threshold variance; and
updating the Boltzmann Machine using a probability distribution of the QUBO.

14. The method of claim 13, further comprising preparing a Hamiltonian.

15. The method of claim 13, further comprising sampling the QUBO on the simulated annealer when the diagonal is not positive semidefinite to obtain one or more samples, wherein the variance includes a variance of at least one dispersion measurement that is determined by the one or more samples.

16. The method of claim 15, wherein the at least one dispersion measurement is one or more of a standard deviation, a value range, or a variance.

17. The method of claim 13, wherein the Boltzmann machine is a restricted Boltzmann machine, a quantum Boltzmann machine, or a quantum restricted Boltzmann machine.

18. The method of claim 13, wherein updating the Boltzmann Machine includes updating gradients and parameters.

19. The method of claim 13, further comprising validating the Boltzmann Machine once convergence is achieved.
